(19) United States
(12) Patent Application Publication
(10) Pub. No.: US 2024/0052901 A1
(43) Pub. Date: Feb. 15, 2024

(54) BRAKING DEVICE

(71) Applicant: Continental Automotive Technologies GmbH, Hannover (DE)

(72) Inventors: Falk Petzold, Frankfurt am Main (DE); Christian Vey, Petersberg (DE); Martin Kruse, Frankfurt am Main (DE); Martin Gädke, Hofheim (DE); Jens Hoffmann, Darmstadt (DE); Uwe Bach, Niedernhausen (DE)

(73) Assignee: Continental Automotive Technologies GmbH, Hannover (DE)

(21) Appl. No.: 18/257,989

(22) PCT Filed: Nov. 25, 2021
(86) PCT No.: PCT/DE2021/200204

§ 371 Date: Jun. 16, 2023

(30) Foreign Application Priority Data
Dec. 16, 2020 (DE) 10 2020 216 023.6

(51) Int. Cl. F16D 65/56; B60T 13/74

(52) U.S. Cl. CPC F16D 65/565; B60T 13/746; F16D 2065/386

(57) ABSTRACT

A brake device for a motor vehicle has an actuator with a common housing for a spreading actuator, and an adjusting device. An electric motor for actuating the actuator can be driven in two rotational directions, the spreading actuator being driven in the one rotational direction, and the adjusting device being driven in the other rotational direction.

### TECHNICAL FIELD

The embodiments relate to a braking device for a motor vehicle, with a brake element for generating a frictionally locking connection to a rotating component.

### BACKGROUND

Braking devices of this type are known, for example, from WO 2015 101 486 A2. An adjusting device is integrated, as a separate component next to an actuator, into a spreading device of a braking device, and prevents a brake pedal travel or travel of the actuator being lengthened as the brake clearance increases in the case of wear of the brake linings. The adjusting device can be adjusted if required.

Developing a braking device of the type mentioned at the outset such that it avoids a complicated adjustment of the brake linings is desired.

### SUMMARY

An adjusting device is arranged in a component of the actuator, and the actuator is configured to drive a spreading actuator starting from a middle initial position in one drive direction, and to drive the adjusting device starting from an initial position in the opposite drive direction.

This avoids the mounting of an additional component of the adjusting device because the adjusting device is mounted together with the remaining components of the actuator. Here, the adjusting device or the spreading actuator can be actuated selectively by way of a corresponding actuation of the actuator. Therefore, the braking device makes an adjustment of the brake linings in the case of wear possible. The described drive directions of the actuator can be specified here by an angle or an axial travel. The braking device can have virtually any desired configuration, for example as a simplex or duo-servo brake.

In accordance with another development, the braking device may have small delay of the generation of the frictionally locking connection after the actuation of the actuator if the initial position is the position of the actuator, in which it is not loaded with energy.

In accordance with another development, the initial position and the drive in the two movement directions may be specified simply if the actuator has an electric motor.

In accordance with another development, the braking device may be manufactured such that the actuator has a housing with pressure pieces arranged therein for supporting the brake elements and the adjusting device. As a result, the actuator can be mounted with the pressure pieces between the brake elements. Here, the adjusting device is mounted at the same time.

In accordance with another development, the drive of the adjusting device and the pressure pieces may be configured to drive a drive sleeve, and the drive sleeve may be configured to actuate the spreading actuator in one rotational direction and to actuate the adjusting device in the other rotational direction.

In accordance with another ] development, the spreading actuator is of structurally particularly simple design if the spreading actuator has two ramp disks which can be rotated counter to one another, if the ramp disks are supported indirectly on the pressure pieces, and if the shape of the ramp disks is configured to enlarge them axially in the case of a rotation counter to one another. The ramp disks can have, for example, inclined grooves on their end sides for receiving rolling bodies, with the result that the rolling bodies roll therein and increase the spacing of the ramp disks from one another.

In accordance with another development, a contribution is made to the further simplification of the construction of the spreading actuator if the actuator has a drive sleeve which is connected via a thread to an axle and can be displaced axially within the housing, and if at least one of the components of the axle or the drive sleeve supports the pressure pieces indirectly or directly.

In accordance with another development, the adjusting device is of structurally particularly simple design if the adjusting device has an adjusting nut which is screwed on the axle via an adjusting thread, and if the adjusting nut is secured in the initial position against rotation in a positively locking or non-positive manner.

The thread might be configured, for example, as a trapezoidal thread. In accordance with another development, the actuation means of the spreading actuator and the adjusting device are of particularly low-friction design if the thread of the drive sleeve is configured on the axle as a ball screw drive.

In accordance with another development, the actuator is of particularly compact design if the adjusting nut is arranged in the force flow between the axle and the one pressure piece. As a result, the entire adjusting device can be displaced during the actuation of the spreading actuator, without the adjusting device being adjusted.

In accordance with another development, the holding, secured against rotation, of the adjusting nut can be of structurally particularly simple design if the adjusting nut has a latching means with a latching disk or with an adjusting spring.

In accordance with another development, the support of the adjusting spring can be of particularly simple design if an adjusting cage engages around the adjusting nut with one end, and supports the adjusting spring with the other end.

### BRIEF DESCRIPTION OF THE DRAWINGS

To further illustrate the basic principle and features, a number of these embodiments are illustrated in the drawing and will be described in the following text. In the drawing:

FIG. 1 diagrammatically shows a braking device which is configured as a drum brake,

FIG. 2 shows a force-displacement diagram of an actuator of the braking device from FIG. 1,

FIG. 3 shows a sectional illustration through a first embodiment of the actuator,

FIG. 4 shows a sectional illustration through the actuator from FIG. 3 along the line IV-IV,

FIG. 5 shows a sectional illustration through a further embodiment of the actuator,

FIG. 6 shows a sectional illustration through a further embodiment of the actuator,

FIG. 7 shows the actuator from FIG. 6 in the case of the actuation of a spreading actuator,

FIG. 8 shows the actuator from FIG. 6 in the case of the actuation of an adjusting device,

FIG. 9 perspectively shows an adjusting nut of an adjusting device of the actuator from FIG. 6,

FIG. 10 shows the adjusting nut from FIG. 7 in a further illustration, and

FIG. 11 shows a part region of the adjusting device from FIG. 6 in an enlarged sectional illustration.

### DETAILED DESCRIPTION

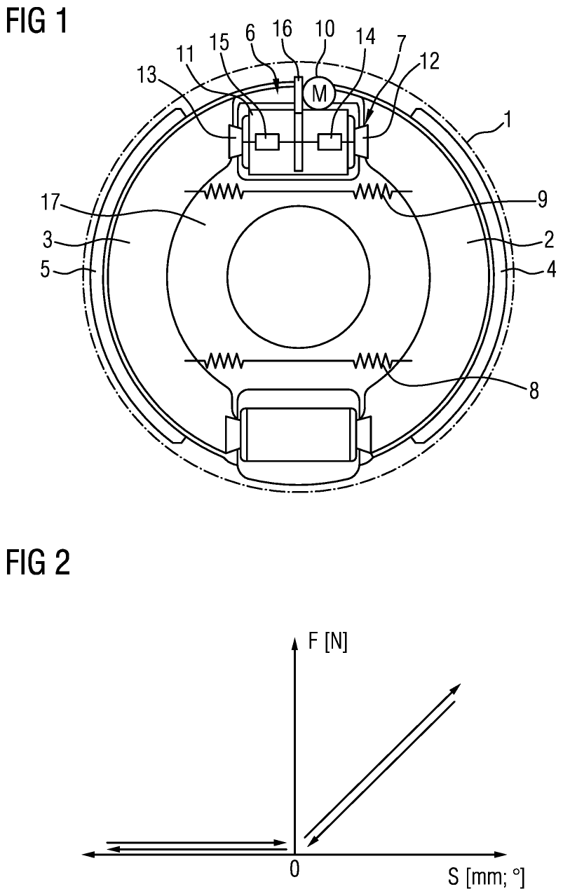

FIG. 1 shows the components of a braking device, configured as a drum brake, of a motor vehicle. The braking device has a rotatably mounted brake drum 1. The brake drum 1 encloses two brake elements 2, 3, configured as brake shoes, with friction linings 4, 5. The brake shoes 2, 3 can be moved against the brake drum 1 by a spreading device 7 which can be driven by an actuator 6, in order to generate a frictional torque. In the exemplary embodiment which is shown, tension springs 8, 9 tension the brake shoes 2, 3 counter to the actuator 6 and therefore make their return movement from the brake drum 1 possible. The actuator 6 has an electric motor 10, which can be driven in the two rotational directions, and a housing 11 for guiding two pressure pieces 12, 13 which are supported on the brake shoes 2, 3. A spreading actuator 14, for driving the spreading device 7, and an adjusting device 15 are arranged within the housing 11. The adjusting device 15 sets the position of the pressure pieces 12, 13 and therefore makes the compensation of the wear of the friction linings 4, 5 possible. A gearwheel 16 which is driven by the electric motor 10 penetrates into the housing 11 with the pressure pieces 12, 13. The housing 11 is mounted on a support plate 17 in a floating manner.

FIG. 2 shows a force-displacement diagram of the actuator from FIG. 1. It can be seen here that, in the uncontrolled initial state, the actuator 6 from FIG. 1 assumes a zero position which is labelled by “0” and in which neither the pressure pieces 12, 13 are loaded with force by means of the spreading actuator 14 nor the adjusting device 15 is actuated. If, starting from the zero position, the electric motor 10 is driven in the one rotational direction, the adjusting device 15 is actuated. If, starting from the zero position, the electric motor is driven in the other rotational direction, the pressure pieces 12, 13 are moved apart from one another by the spreading actuator 14 and introduce a force F into the spreading device.

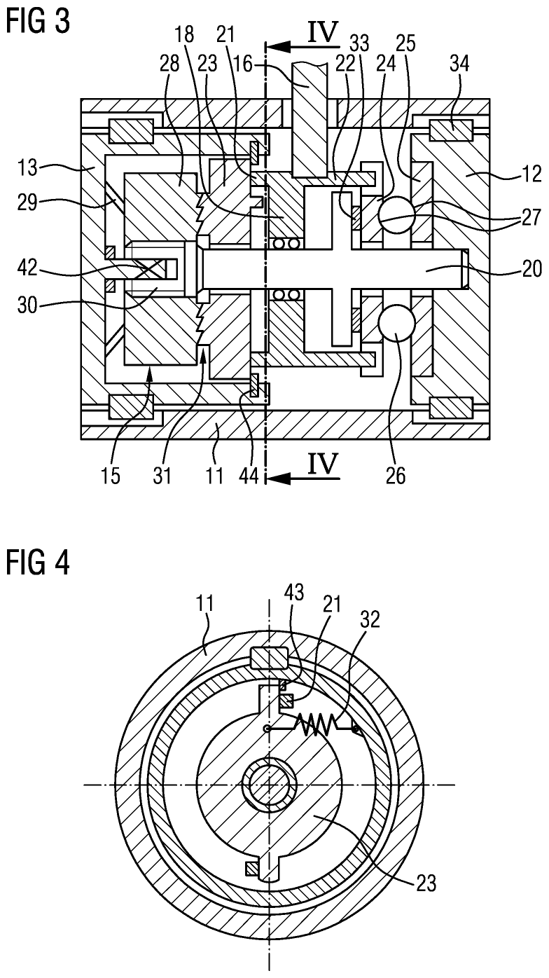

FIG. 3 diagrammatically shows a sectional illustration through the housing 11 of the actuator 6 with the pressure pieces 12, 13 arranged non-rotatably and axially displaceably therein. The gearwheel 16 which is driven by the electric motor 10 from FIG. 1 is shown in partial section. The actuator 6 has, at its ends, the pressure pieces 12, 13 for supporting the brake elements 2, 3 shown in FIG. 1 and, within the housing 11, a drive sleeve 18 which is driven by the gearwheel 16. The drive sleeve 18 is mounted on an axle 20 and is supported via first drivers 21 on a latching disk 23 and via second drivers 22 on a first ramp disk 24. The mounting of the drive sleeve 18 on the axle 20 can take place via a radial bearing or a sliding bush. In the exemplary embodiment shown, the drive sleeve 18 is displaceable. As an alternative, the drive sleeve 18 can be fixed axially on the axle 20 on both sides by way of a securing ring (not shown). The drivers 21, 22 project from the drive sleeve 18 as wing pairs which are arranged on the two sides of the axle 20. Transverse forces are avoided as a result. The first ramp disk 24 is mounted rotatably and is supported on a stationary ramp disk 25. Rolling bodies 26 are arranged between the ramp disks 24, 25. The rolling bodies 26 roll on the grooves 27 which are inclined with respect to the end sides of the ramp disks 24, 25, with the result that the ramp disks 24, 25 are moved axially apart from one another as the rotational angle increases. Here, one of the ramp disks 25 is supported on the one pressure piece 12, and the other one of the ramp disks is supported via an axial bearing 33 on the axle 20 and therefore indirectly on the other pressure piece 13. The pressure pieces 12, 13 are connected to the housing 11 non-rotatably and axially displaceably via axial guides 34. The one pressure piece 12 can be manufactured in one piece with the closest ramp disk 25. The axle 20 has an anti-rotation safeguard 42 in the one pressure piece 13. The drivers 21, 22 are designed in such a way that they rotate the latching disk 23 in the one rotational direction of the drive sleeve 18 and rotate the rotatably mounted ramp disk 24 in the other rotational direction of the drive sleeve 18. Therefore, the drivers 21, 22 fulfill a drive function in the one rotational direction of the drive sleeve 18, and fulfill a freewheel function with the component of the latching disk 23 or the rotatable ramp disk 24 in the other rotational direction.

The latching disk 23 is part of the adjusting device 15 which captures an adjusting nut 28. This adjusting nut 28 is supported via a cup spring 29 on the one pressure piece 13, and is screwed on an adjusting thread 30 of the axle 20. The latching disk 23 and the latching nut 28 have latching means 31 which lie opposite one another, with the result that the adjusting nut 28 is driven in the one rotational direction of the latching disk 23 and is rotated on the adjusting thread 30 of the axle 20 and is therefore displaced. Here, the adjusting nut 28 presses via the cup spring 29 against the one pressure piece 13. In the case of a return movement of the latching disk 23, the adjusting nut 28 remains on the axle 20 as a result of a frictionally locking connection, and the latching disk 23 moves one latching means further. As a result, the spacings of the pressure pieces 12, 13 from one another are increased, and the actuator 6 is adjusted in this way.

FIG. 4 illustrates the configuration of the first driver 21 using the example of the latching disk 23. The latching disk 23 is preloaded against a stop 43 by a restoring spring 32. The first driver bears loosely against the latching disk 23 and can move away from the drive sleeve 18 in the case of a rotation of the latter in the clockwise direction, or can rotate this latching disk 23 counter to the force of the restoring spring 32 in the case of a rotation counter to the clockwise direction. The second drivers 22 for driving the rotatable ramp disk 24 are of analogous construction with the functions in the opposite rotational direction. Therefore, exclusively the adjusting device 15 is adjusted in the case of the drive of the drive sleeve 18 in the one rotational direction, and exclusively the pressure pieces 12, 13 are moved away from one another in the other rotational direction, and the spreading device 7 is therefore driven via the spreading actuator 14.

If the adjustment is activated, the latching disk 23 rotates and drives the adjusting nut 28 with it. The adjusting nut 28 is screwed on the axle 20 and is pressed against the cup spring 29. The cup spring 29 presses against the pressure piece 13. The pressure piece 13 therefore moves in the same direction as the adjusting nut 28. Here, the pressure piece 13 drives the latching disk 23 with it via a securing disk 44. Therefore, the assembly of the adjusting device 15 is displaced with each adjustment. Since the latching disk 23 is also displaced during the adjustment, the contact between the adjusting nut 28 and the latching disk 23 is maintained. If the adjusting device 15 is displaced, the spacing between the drive sleeve 18 and the latching disk 23 also increases.

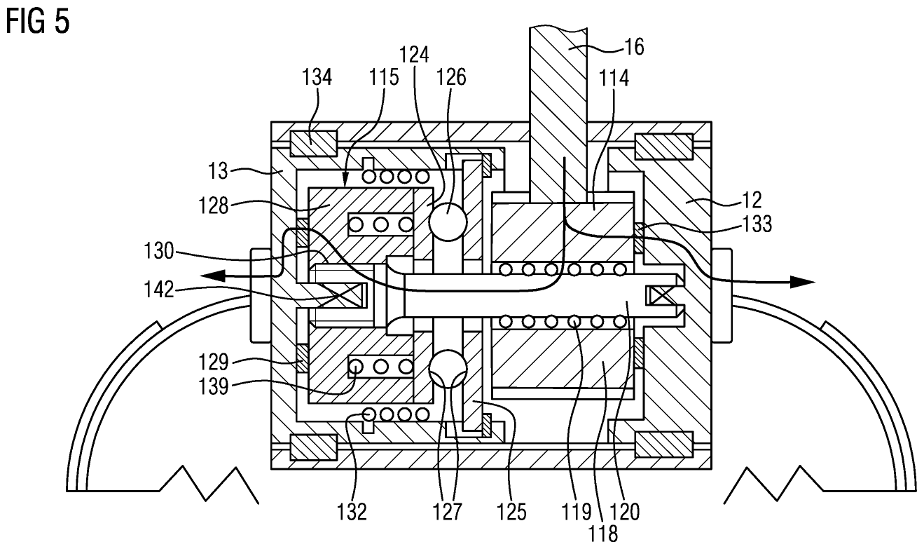

FIG. 5 shows a further embodiment of the actuator 6 with two pressure pieces 12, 13 which can be displaced axially and are held non-rotatably in the housing 11 via axial guides 134, in a diagrammatic sectional illustration. An adjusting device 115 has two ramp disks 124, 125 which lie opposite one another. One of the ramp disks 125 is connected to one of the pressure pieces 13 axially displaceably and fixedly for conjoint rotation, while the other of the ramp disks 124 is connected to an adjusting nut 128 via friction or a positively locking connection. The gearwheel 16 of the electric motor 10 meshes with a drive sleeve 118 as in the case of the embodiment according to FIG. 3. The drive sleeve 118 is connected to an axle 120 via a thread 119 which is configured as a ball screw drive. The adjusting nut 128 is screwed with an adjusting thread 130 on the axle 120.

A strong adjusting spring 139 in the interior of the adjusting screw 128 generates an axial force on the ramp disk 124, in order to hold rolling bodies 126, arranged in between and configured as balls, between the ramp disks 124, 125. The ramp disk 125 which is connected fixedly to the one pressure piece 13 for conjoint rotation supports the force of the adjusting spring 139 via a cup spring 129 on the pressure piece 13.

In the uncontrolled initial position, the ramp disks 124, 125 are rotated with respect to one another and are preloaded into their position. The adjusting spring 139 in the interior of the adjusting nut 128 preloads the ramp disks 124, 125 against the rolling bodies 126. The ramp disk 124 which is connected to the adjusting nut 128 is held in its rotational position by way of friction. In addition, a restoring spring 132 holds the ramp disks 124, 125 in their rotated and preloaded position. Here, the restoring spring 132 is in a non-tensioned rest position. An axial displacement of the ramp disks 124, 125 leads to tensioning of the torsion spring. If the driven drive sleeve 118 of the thread 119 which is configured as a ball screw drive then presses against the ramp disk 125, the ramp disks 124, 125 are rotated and in the process pressed together axially, and the restoring spring 132 is preloaded. The axial force generate so much frictional force between the one ramp disk 124 and the adjusting nut 128 that the adjusting nut 128 is rotated, generates adjusting stroke and thus increases the spacing between the pressure pieces 12, 13.

If the driven drive sleeve 118 of the thread 119 which is configured as a ball screw drive then moves back into the illustrated initial position, the friction between the ramp disk 124 and the adjusting nut 128 decreases again. The preloaded restoring spring 132 moves the rotatable ramp disk 124 back again in the process. A sufficiently high friction which is possibly generated artificially in the adjusting thread 130 ensures that the adjusting nut 128 is not reset during the relieving of the restoring spring 132.

If the drive sleeve 118 is driven in the one rotational direction, it is displaced and presses via an axial bearing 133 on the one pressure piece 12. The other pressure piece 13 is moved via the axle 120 in the other direction, without rotating in the process. The axle 120 has an anti-rotation safeguard 142 in the pressure pieces 12, 13. The adjusting device 115 is not influenced during this movement. In this way, the spreading device 7 which is shown in FIG. 1 is driven. In order to dissipate the spreading force, the driving sleeve 118 is driven in the opposite direction into the initial position.

The adjustment takes place when the drive sleeve 118 is driven out of the initial position in the other rotational direction in the direction of the ramp disks 124, 125.

The driven drive sleeve 118 of the thread 119 which is configured as a ball screw drive presses axially. If an axial force acts on the ramp disk 125 which is secured against rotation, the rotatable ramp disk 124 is rotated via inclined grooves 127 and rolling bodies 126 arranged therein, and drives the adjusting nut 128 with it via friction or a positively locking connection. The restoring spring 132 is tensioned in the process. The rotation of the adjusting nut 128 leads to an axial displacement of the axle 120 which is secured against rotation and therefore to an increase in the spacing of the pressure pieces 12, 13. When the drive sleeve 118 is subsequently moved back into the initial position, the ramp disks 124, 125 are relieved by the axial prestress of the drive sleeve 118. The tensioned restoring spring 132 can therefore reset into the rest position. Here, the restoring spring 132 drives the rotatable ramp disk 124 with it, with the result that the two ramp disks 124, 125 are again rotated with respect to one another.

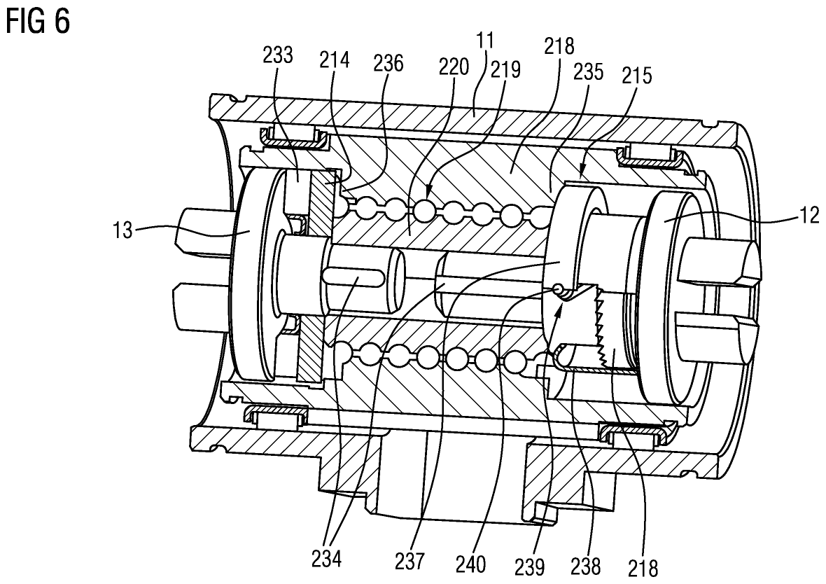

FIG. 6 shows a further embodiment of the actuator 6 of the braking device from FIG. 1, in the case of which embodiment a drive sleeve 218 which can be rotated in the housing 11 and can be driven by the electric motor 10 via the gearwheel 16 from FIG. 1 is mounted on a tubular axle 220 via a thread 219 which is configured as a ball screw drive. Two pressure pieces 12, 13 which are arranged within the drive sleeve 218 and can be rotated with respect to the latter are secured against rotation by the brake elements 2, 3 from FIG. 1 and are preloaded into the drive sleeve 218 by the tension springs 8, 9 which are likewise shown in FIG. 1. The tubular axle 220 has axial guides 234 for guiding the pressure pieces 12, 13 in a manner which is fixed so as not to rotate and can be displaced axially. An axial bearing 233 of a spreading actuator 214 is arranged between the one pressure piece 13 and the end of the axle 220, while an adjusting device 215 is arranged between the other pressure piece 12 and the axle 220. In addition, the drive sleeve 218 lies with radially inwardly pointing shoulders 235, 236 opposite the axial bearing 233 and the adjusting device 215. The adjusting device 215 has an adjusting nut 228, a sliding ring 237 and an adjusting cage 238. The adjusting nut 228 is screwed on an adjusting thread 230 (shown in FIG. 11) of the one pressure piece 12. An adjusting spring 239 is deflected on a sliding ring pin 240. The sliding ring 237 is guided axially by the sliding ring pin 240.

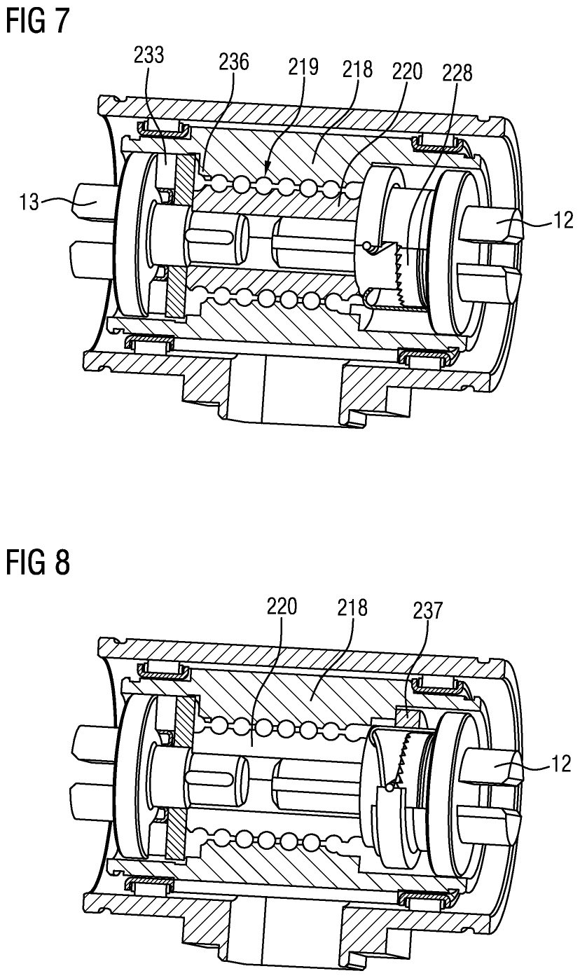

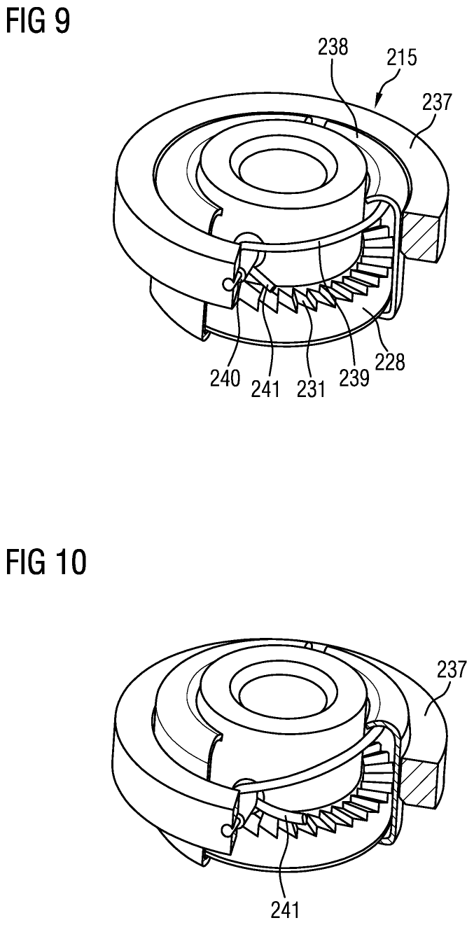

In order to actuate the spreading actuator 214, the drive sleeve 218 is rotated by way of the electric motor 10 (shown in FIG. 1), as is shown in FIG. 7. By way of the rotational movement, the axle 220 is pressed against the adjusting nut 228 via the thread 219 which is configured as a ball screw drive, as a result of which the one pressure piece 12 is loaded with force. On the other side, the drive sleeve 218 is supported on the axial bearing 233, as a result of which the other pressure piece 13 is loaded with force. In this way, the pressure pieces 12, 13 drive the spreading device 7 from FIG. 1. The adjusting device 215 is situated in the illustrated position which is shown with an enlarged scale in FIG. 9 for clarification purposes. One leg 241 of the adjusting spring 239 is supported in a latching means 231 of the adjusting nut 228, while the other end of the adjusting spring 239 is supported on the adjusting cage 238.

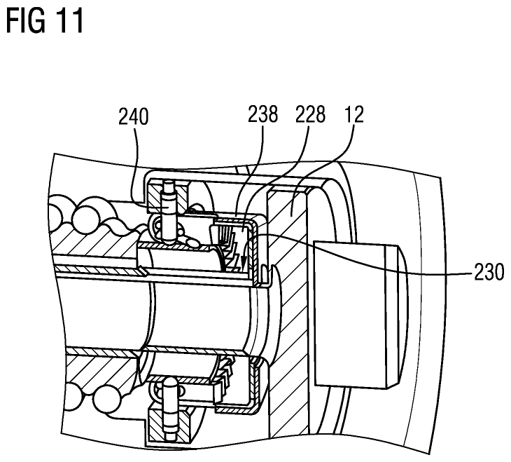

In order to actuate the adjusting device 215, the drive sleeve 218 is rotated in the opposite direction, as is shown in FIG. 8. Here, the drive sleeve 218 presses the sliding ring 237 axially in the direction of the closest pressure piece 12. By way of the axially displaceable coupling of the sliding ring 237 with the sliding ring pin 240, the leg 241 of the adjusting spring 239 is pivoted around the sliding ring pin 240, as is shown with an enlarged scale in FIG. 10 for clarification purposes. Since the free end of the leg 241 is supported in the latching means 231 of the adjusting nut 228, the latter is rotated. When the drive sleeve 218 is rotated back into the initial state again, the adjusting nut 228 remains in its position, since it is held by way of a non-positive connection on the axle 220 and on the adjusting thread 230 of the pressure piece 12. This non-positive connection is assisted by way of the tension springs 8, 9 which are shown in FIG. 1. The adjusting string 239 can be relieved again, and the free leg 241 can be moved one latching means further again in the adjusting means 228 as a result of the released travel.

FIG. 11 shows that part region of the adjusting device 215 which has the adjusting nut 228, in an enlarged partial section. The adjusting cage 238 is guided in the pressure piece 12 in a manner which is axially displaceable and secured against rotation. By way of this guide, in addition, the sliding ring 237 is guided via the sliding ring pin 240 in the adjusting cage 238 in a manner which is axially displaceable and secured against rotation.

1. A drum brake device for a motor vehicle comprising:
a brake element for generating a frictionally locking connection to a rotating component;
an actuator which can be driven in two movement directions and moves the brake element toward the rotating component and away from the rotating component;
an adjusting device for compensating for wear of the components which generate the frictionally locking connection;
wherein the adjusting device is arranged in the component of the actuator, and in that the actuator is configured to drive a spreading actuator starting from a middle initial position in one drive direction, and to drive the adjusting device starting from the initial position in the opposite drive direction.

2. The drum brake device as claimed in claim 1, wherein the initial position is the position of the actuator, in which it is not loaded with energy.

3. The drum brake device as claimed in claim 1, wherein the actuator has an electric motor.

4. The drum brake device as claimed in claim 1, wherein the actuator has a housing with pressure pieces arranged therein for supporting the brake elements and the adjusting device.

5. The drum brake device as claimed in claim 3, wherein the electric motor is configured to drive a drive sleeve, and the drive sleeve is configured to actuate the spreading actuator in one rotational direction and to actuate the adjusting device in the other rotational direction.

6. The drum brake device as claimed in claim 1, wherein the spreading actuator has two ramp disks which can be rotated counter to one another, in that the ramp disks are supported indirectly on the pressure pieces, and the shape of the ramp disks is configured to enlarge them axially in the case of a rotation counter to one another.

7. The drum brake device as claimed in claim 5, wherein the actuator has a drive sleeve which is connected via a thread to an axle and can be displaced axially within the housing, and in that at least one of the components of the axle or the drive sleeve supports the pressure pieces indirectly or directly.

8. The drum brake device as claimed in claim 1, wherein the adjusting device has an adjusting nut which is screwed on the axle via an adjusting thread, and the adjusting nut is secured in the initial position against rotation in a positively locking or non-positive manner.

9. The drum brake device as claimed in claim 7, wherein the thread of the drive sleeve is configured on the axle as a ball screw drive.

10. The drum brake device as claimed in claim 1, wherein the adjusting nut is arranged in the force flow between the axle and the one pressure piece.

11. The drum brake device as claimed claim 1, wherein the adjusting nut has a latching means with a latching disk or with an adjusting spring.

12. The drum brake device as claimed in claim 1, wherein an adjusting cage engages around the adjusting nut with one end, and supports the adjusting spring with the other end.
